(19) United States
(12) Patent Application Publication
(10) Pub. No.: US 2018/0142329 A1
(43) Pub. Date: May 24, 2018

(54) PROCESS FOR THE PRODUCTION OF A PGM-ENRICHED ALLOY

(71) Applicants: Heraeus Deutschland GmbH & Co. KG, Hanau (DE); Heraeus Precious Metals North America LLC, Santa Fe Springs, CA (US)

(72) Inventors: Felix STOFFNER, Aschaffenburg (DE); Chris HOBBS, Knoxville, TN (US)

(21) Appl. No.: 15/355,897

(22) Filed: Nov. 18, 2016

(51) Int. Cl. C22C 19/03; C22C 1/02; C22C 1/06; F27D 3/16; F27B 14/14

(52) U.S. Cl. CPC C22C 19/03; C22C 1/023; F27D 2003/169; F27D 3/16; F27B 14/143; C22C 1/06

(57) ABSTRACT

A gas lance which can be used in a process of any one of the preceding claims, said gas lance comprising or consisting of a rod having inner channels along its length axis, wherein the rod is made of a non-oxidizable ceramic material having a melting point above 1800° C. The gas lance can be used in a pyrometallurgical process for the production of a PGM-enriched alloy.

The invention relates to a pyrometallurgical converting process for the production of a PGM-enriched alloy (PGM=platinum group metal) and to a gas lance which can be used in such process.

The abbreviation “PGM” used herein means platinum group metal.

In general, the enrichment of PGMs by means of pyrometallurgical converting is well-known, see, for example, S. D. MCCULLOUGH, Pyrometallurgical iron removal from a PGM-containing alloy, Third International Platinum Conference ‘Platinum in Transformation’, The Southern African Institute of Mining and Metallurgy, 2008, pages 1-8.

The process of the invention is a pyrometallurgical converting process which employs a gas lance for the supply of oxidizing gas.

The process of the invention is a process for the production of a PGM-enriched alloy comprising at least one PGM selected from the group consisting of platinum, palladium and rhodium. The process comprises the steps:
(1) providing a PGM collector alloy comprising collector metal and one or more PGMs selected from the group consisting of platinum, palladium and rhodium,
(2) providing a material capable of forming a slag-like composition when molten,
(3) melting the PGM collector alloy and the material capable of forming a slag-like composition when molten within a converter until a multi- or two-phase system of a lower high-density molten mass comprising the molten PGM collector alloy and one or more upper low-density molten masses comprising the molten slag-like composition has formed,
(4) contacting an oxidizing gas comprising 0 to 80 vol.-% of inert gas and 20 to 100 vol.-% of oxygen with the lower high-density molten mass obtained in step (3) until it has been converted into a lower high-density molten mass of the PGM-enriched alloy,
(5) separating an upper low-density molten slag formed in the course of step (4) from the lower high-density molten mass of the PGM-enriched alloy making use of the difference in density,
(6) letting the molten masses separated from one another cool down and solidify, and
(7) collecting the solidified PGM-enriched alloy,
   wherein the contact between the oxidizing gas and the lower high-density molten mass is made by passing the oxidizing gas into the lower high-density molten mass by means of a gas lance the oxidizing gas exhaust of which being immersed into the lower high-density molten mass,
   wherein the gas lance comprises or consists of a rod having inner channels along its length axis,
   wherein the rod is made of a non-oxidizable ceramic material having a melting point higher than the temperatures prevailing during step (4), and
   wherein the oxidizing gas is supplied through at least one of said inner channels.

“0 wt.-%” or “0 vol.-%” appears several times in the description and the claims; it means that the respective component is not present or, if present, it is at best present in a proportion of no more than at a technically inevitable impurity level.

The process of the invention is a process for the production of a PGM-enriched alloy comprising one or more PGMs selected from the group consisting of platinum, palladium and rhodium. It is preferred that the PGM-enriched alloy produced by the process of the invention comprises iron, for example >0 to 60 wt.-% of iron, and one or more of said PGMs, for example 20 to <100 wt.-% of one or more of said PGMs. The PGM-enriched alloy made by the process of the invention may comprise nickel and copper. Examples of other elements (elements other than iron, nickel, copper, platinum, palladium and rhodium) which may be comprised by the PGM-enriched alloy made by the process of the invention include, in particular, silver, gold, aluminum, calcium, phosphorus and silicon.

In step (1) of the process of the invention a PGM collector alloy is provided. PGM collector alloys are well-known to the person skilled in the art; they may typically be formed during pyrometallurgic recycling of appropriate PGM containing waste material like, for example, PGM containing waste catalysts, for example, used automotive exhaust catalysts. In the course of such pyrometallurgic recycling the PGMs are separated by smelting the PGM containing waste material, for example, ceramic supports having a PGM containing washcoat (like used automotive exhaust catalysts) together with a collector metal like, for example, iron in an oven, a so-called smelter. The PGMs form a PGM collector alloy with the collector metal, which is separated from slag formed as by-product during smelting.

The PGM collector alloy provided in step (1) comprises collector metal and one or more PGMs selected from the group consisting of platinum, palladium and rhodium, for example, 2 to 15 wt.-% of said one or more PGMs. The collector metal may comprise one, two or more collector metals, for example, iron alone or iron and nickel. The PGM collector alloy may comprise, for example, 30 to 95 wt.-% of iron and 2 to 15 wt. % of one or more PGMs selected from the group consisting of platinum, palladium and rhodium. In an embodiment, the PGM collector alloy may comprise 40 to 70 wt.-% of iron, 0 to 20 wt.-% of nickel and 5 to 15 wt.-% of one or more of said PGMs. Examples of one or more other elements (elements other than iron, nickel, platinum, palladium and rhodium) which may be comprised by the PGM collector alloy include silver, gold, copper, aluminum, calcium, silicon, sulfur, phosphorus, titanium, chromium, manganese, molybdenum and vanadium.

If the PGM collector alloy comprises silicon, there may be two variants. In a first variant the silicon content of the PGM collector alloy may be in the range of 0 to 4 wt.-%, in a second variant it may be in the range of >4 to 15 wt.-%.

In step (2) of the process of the invention a material capable of forming a slag-like composition when molten is provided.

The term “material capable of forming a slag-like composition when molten” used herein shall illustrate that the molten material looks and behaves like a slag. It shall at the same time express that it is not to be confused with the slag formed as by-product of the process of the invention, i.e. the slag obtained after conclusion of step (4). Moreover, the material capable of forming a slag-like composition when molten is not necessarily identical in composition with the one or more upper low-density molten masses formed in step (3), although it forms at least a predominant part of the latter.

The material capable of forming a slag-like composition when molten may have a composition such that the molten slag-like composition comprises or consists of magnesium oxide and/or calcium oxide, silicon dioxide, and the in each case optional components: iron oxide (in particular FeO), sodium oxide, boron oxide and aluminum oxide. The molten slag-like composition may comprise or consist of, for example, 40 to 90 wt.-% of magnesium oxide and/or calcium oxide, 10 to 60 wt.-% of silicon dioxide, 0 to 20 wt.-%, in particular 0 wt.-% of iron oxide, 0 to 10 wt.-% of sodium oxide, 0 to 10 wt. % of boron oxide, and 0 to 2 wt.-%, in particular 0 wt.-% of aluminum oxide.

If the silicon content of the PGM collector alloy provided in step (1) is in the range of 0 to 4 wt.-%, it is expedient that the material capable of forming a slag-like composition when molten has a composition such that the molten slag-like composition comprises or consists of:
40 to 60 wt.-% of magnesium oxide and/or calcium oxide,
40 to 60 wt.-% of silicon dioxide,
0 to 20 wt.-%, in particular 0 wt.-% of iron oxide (in particular FeO),
0 to 20 wt.-%, in particular 0 to 10 wt.-% of sodium oxide,
0 to 20 wt.-%, in particular 0 to 10 wt.-% of boron oxide, and
0 to 2 wt.-%, in particular 0 wt.-% of aluminum oxide.

If the silicon content of the PGM collector alloy provided in step (1) is in the range of >4 to 15 wt.-%, it is expedient that the material capable of forming a slag-like composition when molten has a composition such that the molten slag-like composition comprises or consists of:
60 to 90 wt.-% of magnesium oxide and/or calcium oxide,
10 to 40 wt.-% of silicon dioxide,
0 to 20 wt.-%, in particular 0 wt.-% of iron oxide (in particular FeO),
0 to 20 wt.-%, in particular 0 to 10 wt.-% of sodium oxide,
0 to 20 wt.-%, in particular 0 to 10 wt.-% of boron oxide, and
0 to 2 wt.-%, in particular 0 wt.-% of aluminum oxide.

In an embodiment, and apart from said wt.-% proportions of silicon dioxide and magnesium oxide and/or calcium oxide, the material capable of forming a slag-like composition when molten has a composition such that the molten slag-like composition comprises no iron oxide, 0 to 10 wt.-% of sodium oxide, 0 to 10 wt.-% of boron oxide and no aluminum oxide.

The material capable of forming a slag-like composition when molten and, as a consequence thereof, also the molten slag-like composition itself does not comprise PGMs with the exception of technically inevitable impurities. However, if the latter is present its proportion should be low; preferably such proportion does not exceed, for example, 10 wt.-ppm in the material capable of forming a slag-like composition when molten.

The material capable of forming a slag-like composition when molten is a combination of substances and may comprise the afore mentioned oxides or only said oxides, however, this is not necessarily the case. It may instead or additionally comprise compounds capable of forming such oxides or oxide compositions when heated during formation of the one or more upper low-density molten masses. To name just a few examples of such type of compounds: carbonates are examples of compounds which may split off carbon dioxide and form the corresponding oxides when heated and melted during formation of the one or more upper low-density molten masses; silicates are examples of compounds which may form the corresponding oxides and silicon dioxide when heated and melted during formation of the one or more upper low-density molten masses; borates are examples of compounds which may form the corresponding oxides and boron oxide when heated and melted during formation of the one or more upper low-density molten masses.

In step (3) of the process of the invention the PGM collector alloy and the material capable of forming a slag-like composition when molten are melted within a converter until a multi- or two-phase system of a lower high-density molten mass comprising the molten PGM collector alloy and one or more upper low-density molten masses comprising the molten slag-like composition has formed or, in an embodiment, until a two-phase system of a lower high-density molten mass comprising the molten PGM collector alloy and an upper low-density molten mass comprising the molten slag-like composition has formed. The PGM collector alloy and the material capable of forming a slag-like composition when molten may be melted in a weight ratio of, for example, 1:0.2 to 1, preferably 1:0.2 to 0.6.

The converter is a conventional pyrometallurgical converter vessel or crucible furnace which allows for melting the PGM collector alloy and the material capable of forming a slag-like composition when molten. The converter has one or more openings at its top and it may have a cylinder- or pear-like shape, for example. Its construction may be such that it allows for a rotating and/or rocking movement to allow support of mixing of its contents. Preferably it is tiltable to allow for pouring out molten content thus enabling performing step (5) of the process of the invention. Its inner which has contact with the multi- or two-phase system of the lower high-density molten mass and the one or more upper low-density molten masses is of a heat-resistant material as is conventional for pyrometallurgical converter vessels, i.e. a material which withstands the high temperatures prevailing in process steps (3) and (4) and which is essentially inert towards the components of said multi- or two-phase system. Examples of useful heat-resistant materials include silica bricks, fireclay bricks, chrome-corundum bricks, zircon mullite bricks, zircon silicate bricks, magnesia bricks and calcium aluminate bricks.

In the course of step (3), first of all, the PGM collector alloy and the material capable of forming a slag-like composition when molten are introduced into the converter, either as premix or as separate components. The process of the invention is a batch process and it is preferred not to introduce the entire batch all at once and then to heat and melt the contents of the converter, but to introduce the materials to be melted portionwise and adapted to the melting speed. Once the entire batch has melted, said multi- or two-phase system of a lower high-density molten mass and the one or more upper low-density molten masses is obtained.

Heating of the converter contents in order to melt the latter and thus form the multi- or two-phase system means raising the temperature of the converter contents to, for example, 1200 to 1800° C., preferably 1500 to 1700° C. Such heating may be performed by various means either alone or in combination, i.e., for example, plasma heating, indirect electrical heating, arc heating, inductive heating, indirect heating with burners, direct heating with one or more gas burners from the above and any combination of said heating methods. Direct heating with gas burners capable of producing said high temperatures is a preferred method. Examples of useful gas burners include gas burners run with hydrogen or a hydrocarbon-based fuel gas and oxygen or nitrous oxide as oxidant.

After conclusion of step (3), i.e. once the multi- or two-phase system has formed, step (4) of the process of the invention is performed. In step (4) an oxidizing gas comprising or consisting of 0 to 80 vol.-% of inert gas and 20 to 100 vol.-% of oxygen, preferably 0 to 50 vol.-% of inert gas and 50 to 100 vol.-% of oxygen, in particular 0 vol.-% inert gas and 100 vol.-% of oxygen (i.e. oxygen gas) is contacted with the lower high-density molten mass obtained in step (3) until the latter has been converted into a lower high-density molten mass of the PGM-enriched alloy, i.e. until the PGM-enriched alloy, has formed. Any gas inert towards the lower high-density molten mass can be taken as the inert gas, in particular argon and/or nitrogen.

The contact with the oxidizing gas leads to an exothermic oxidation reaction in the course of which nonprecious elements or metals are converted into oxides and absorbed by the one or more upper low-density molten masses. This oxidation process of step (4) results in depletion of elements or metals other than the PGMs, in particular in depletion of iron and, if present, other nonprecious elements or metals within the lower high-density molten mass or, if taking the reverse view, in PGM enrichment within the lower high-density molten mass.

The contact between the oxygen or oxygen containing oxidizing gas and the lower high-density molten mass is made by passing or bubbling the oxidizing gas into the lower high-density molten mass by means of a gas lance the oxidizing gas exhaust of which being immersed into the lower high-density molten mass. The duration of the contact with the oxidizing gas or, in other words, the amount of oxidizing gas employed depends on when the PGM-enriched alloy of a desired composition has formed. In still other words, the contact with the oxidizing gas is maintained for such period of time, until a PGM-enriched alloy with a desired composition has formed; this will typically take 1 to 5 hours or 2 to 4 hours, for example. The development of the composition of the lower high-density molten mass during performance of step (4) until the PGM-enriched alloy of the desired composition has formed, can be tracked by standard analytical techniques, for example, XRF (X-ray fluorescence) analysis. As by-product an upper low-density molten slag is formed in the course of step (4).

The oxidizing gas exhaust of the gas lance is immersed into the lower high-density molten mass thus enabling passing or bubbling the oxidizing gas leaving the exhaust into the lower high-density molten mass. There is no need to immerse the exhaust deeply into the lower high-density molten mass. Rather, it is preferred to choose an only low immersion depth in the range of from, for example, >0 to 10 cm.

The size of the gas lance depends of course on the process' batch size and the shape and dimensions of the converter. To illustrate, in case of a converter with a total inner volume of, for example, 500 liters, the length of the gas lance from its top to its bottom may be in the range of from, for example, 1 to 3 meters.

The gas lance comprises or consists of a rod having inner channels along its length axis or, in other words, parallel to its length axis. The number of inner chancels may be in the range of, for example 4 to 30.

The rod and/or its inner channels may have any cross-sectional shape, e.g. circular or other than a circle. Examples of cross-sectional shapes other than a circle include triangular, square or hexagonal cross-sections. The overall cross-sectional area of the rod itself may be in the range of from 7 to 80 cm². For example, in case of a circular rod its diameter may be in the range of, for example, 3 to 10 cm. The cross-sectional area of an inner channel may be in the range of, for example, 3 to 80 mm². Inner channels with circular cross-section may have a diameter in the range of, for example, 2 to 10 mm.

It is preferred that the rod with its inner channels has a symmetrical cross-section, i.e. a symmetrical arrangement of the inner channels. In an embodiment, the inner channels may be an arrangement of a central inner channel surrounded by the other inner channels.

The rod is made of a non-oxidizable ceramic material having a melting point higher than the temperatures prevailing during step (4), for example, above 1800° C., in particular in a range of above 1800 to 2800° C. Examples of such ceramic materials include alumina (aluminum oxide), zirconia (zirconium oxide), titanium dioxide, magnesium oxide, zinc oxide and aluminum titanate. Aluminum oxide is preferred as non-oxidizable ceramic material.

The gas lance exhibits a high mechanical stability even under the conditions prevailing in process step (4).

The gas lance in the form of said rod having said inner channels can be made by extrusion, as is conventional in the manufacture of ceramics.

The oxidizing gas is supplied through at least one of said inner channels of said ceramic rod into the lower high-density molten mass, i.e. the oxidizing gas flows in downward direction (top down along the gas lance's length axis) to the oxidizing gas exhaust at the bottom of the gas lance, said oxidizing gas exhaust being immersed into the lower high-density molten mass. Examples of said supply of oxidizing gas include (i) supply of oxidizing gas through all inner channels in downward direction, (ii) supply of oxidizing gas only through the central inner channel while at the same time cooling gas is supplied through the other inner channels, and (iii) supply of oxidizing gas through two or more central inner channels while at the same time cooling gas is supplied in downward direction through the other inner channels or, in other words, through the more peripheral inner channels surrounding said two or more central inner channels.

In an embodiment of the process of the invention, the oxidizing gas and the cooling gas have the same composition. In such embodiment air may be used as oxidizing gas and as cooling gas.

It goes without saying that the gas lance takes a non-horizontal orientation during the oxidizing gas supply of step (4). The orientation will typically be vertical or deviating from a vertical orientation by no more than 30°, for example. In other words, the gas lance has a bottom end and a top end.

The bottom opening(s) of the at least one inner channel through which the oxidizing gas is supplied comprise or form the oxidizing gas exhaust. In a simple embodiment, the bottom opening(s) is/are the oxidizing gas exhaust. In another embodiment, the bottom opening(s) may comprise the oxidizing gas exhaust, for example, in the form of one or more nozzles. The oxidizing gas exhaust or said nozzle(s) may be made of stainless steel.

The bottom openings of the inner channels through which cooling gas is supplied comprise or form the cooling gas exhaust. In a simple embodiment, the bottom openings are the cooling gas exhaust. In another embodiment, the bottom openings may comprise the cooling gas exhaust, for example, in the form of nozzles. The cooling gas exhaust or said nozzles may be made of stainless steel.

The oxidizing gas or said cooling gas is fed into the respective inner channels at the top openings thereof.

As already afore mentioned, the gas lance is capable of being cooled by a cooling gas like air. If the process of the invention employs gas-cooling of the gas lance, which is a preferred embodiment, the cooling gas is typically supplied in the form of compressed air of ambient temperature. The cooling gas supply to bottom openings of the gas lance's inner channels means that the cooling gas after having left said bottom openings escapes into the lower high-density molten mass and will pass or bubble into it, just like the oxidizing gas. Once the cooling gas has left the bottom openings of inner channels and has performed its cooling task, it might also help in moving the hotspot of the oxidation reaction a bit distant from or below the oxidizing gas exhaust. It might also help in shortening the duration of step (4). It goes without saying that the main cooling effect of the cooling gas is developed in the bottom region of the gas lance. It is an advantage that the strongest cooling effect is achieved at the bottom end of the gas lance, where the highest temperatures due to the oxidation develop. Finally, the cooling gas or any non-reacted constituents thereof will escape into the atmosphere, for example. It is believed, although not confirmed by tests or detailed investigation, that the gas-cooling does not only simply cool the gas lance. More precisely, it is believed, that the gas-cooling does not only cool the gas lance's outer surface facing the conditions prevailing in step (4). It appears that the gas-cooling allows for the formation of a layer of refractory material on said outer surface, for example, in the form of a crust of oxidic material comparable with a thin crust of solidified slag. It is believed that such crust behaves as a thermal insulator and/or as a protective shield against the chemical environment the outer surface of the gas lance is exposed to during step (4).

After conclusion of step (4), i.e. once the PGM-enriched alloy of the desired composition has formed, the gas-cooled gas lance is removed from the converter contents and step (5) of the process of the invention is performed. In said step (5) the upper low-density molten slag formed in the course of step (4) is separated from the lower high-density molten mass of the PGM-enriched alloy making use of the difference in density. To this end, the content of the converter is carefully poured out making use of the well-known decantation principle. Once the upper low-density molten slag is decanted the lower high-density molten mass of the PGM-enriched alloy is poured into suitable containers.

Steps (3) to (5) of the process of the invention constitute a sequence of steps, in particular in direct succession. This needs to be understood in such sense that no further steps or at least no further fundamental steps are required or performed between or during said steps (3) to (5). Examples of optional non-fundamental steps are (i) the removal of part of upper low-density molten mass in the course of step (4) or (ii) addition of PGM collector alloy and/or material capable of forming a slag-like composition when molten in the course of step (4).

After conclusion of step (5) subsequent step (6) is performed, in which the separated molten masses are allowed to cool down and solidify.

After solidification the solidified PGM-enriched alloy is collected in step (7). It may then be subject to further conventional refinement, for example, electrometallurgical and/or hydrometallurgical refinement in order to finally obtain the individual PGMs either as metal or as PGM compound or as a solution of the latter.

The PGM-enriched alloy collected in step (7) is distinguished by a relatively high PGM content. This relatively high PGM content means less effort and less consumption of chemicals with a view to said further refinement processes.

In view of the foregoing disclosure the skilled person will understand that the invention relates also to a gas lance according to any of its afore disclosed embodiments. Hence, the invention relates also to a gas lance comprising or consisting of a rod having inner channels along its length axis,

wherein the rod is made of a non-oxidizable ceramic material having a melting point above 1800° C.

Such gas lance can be used in a pyrometallurgical converting process for the production of a PGM-enriched alloy from a PGM collector alloy, in particular, for a supply of oxidizing gas and, optionally, cooling gas in such process, as disclosed in the foregoing.

The invention comprises the following embodiments:
1. A process for the production of a PGM-enriched alloy comprising at least one PGM selected from the group consisting of platinum, palladium and rhodium, the process comprising the steps:
   (1) providing a PGM collector alloy comprising collector metal and one or more PGMs selected from the group consisting of platinum, palladium and rhodium,
   (2) providing a material capable of forming a slag-like composition when molten,
   (3) melting the PGM collector alloy and the material capable of forming a slag-like composition when molten within a converter until a multi- or two-phase system of a lower high-density molten mass comprising the molten PGM collector alloy and one or more upper low-density molten masses comprising the molten slag-like composition has formed,
   (4) contacting an oxidizing gas comprising 0 to 80 vol.-% of inert gas and 20 to 100 vol.-% of oxygen with the lower high-density molten mass obtained in step (3) until it has been converted into a lower high-density molten mass of the PGM-enriched alloy,
   (5) separating an upper low-density molten slag formed in the course of step (4) from the lower high-density molten mass of the PGM-enriched alloy making use of the difference in density,
   (6) letting the molten masses separated from one another cool down and solidify, and
   (7) collecting the solidified PGM-enriched alloy,
      wherein the contact between the oxidizing gas and the lower high-density molten mass is made by passing the oxidizing gas into the lower high-density molten mass by means of a gas lance the oxidizing gas exhaust of which being immersed into the lower high-density molten mass,
      wherein the gas lance comprises or consists of a rod having inner channels along its length axis,
      wherein the rod is made of a non-oxidizable ceramic material having a melting point higher than the temperatures prevailing during step (4), and
      wherein the oxidizing gas is supplied through at least one of said inner channels.
2. The process of embodiment 1, wherein the PGM-enriched alloy comprises >0 to 60 wt.-% of iron and 20 to <100 wt.-% of the one or more PGMs.
3. The process of embodiment 1 or 2, wherein the PGM collector alloy provided in step (1) comprises 30 to 95 wt.-% of iron and 2 to 15 wt.-% of one or more PGMs selected from the group consisting of platinum, palladium and rhodium.
4. The process of any one of the preceding embodiments, wherein the molten slag-like composition comprises or consists of 40 to 90 wt.-% of magnesium oxide and/or calcium oxide, 10 to 60 wt.-% of silicon dioxide, 0 to 20 wt.-% of iron oxide, 0 to 10 wt. % of sodium oxide, 0 to 10 wt.-% of boron oxide, and 0 to 2 wt.-% of aluminum oxide.
5. The process of embodiment 4, wherein (i) the PGM collector alloy comprises 0 to 4 wt.-% of silicon and wherein the the molten slag-like composition comprises 40 to 60 wt.-% of magnesium oxide and/or calcium oxide and 40 to 60 wt.-% of silicon dioxide or (ii) wherein the PGM collector alloy comprises >4 to 15 wt.-% of silicon and wherein the the molten slag-like composition comprises 60 to 90 wt.-% of magnesium oxide and/or calcium oxide and 10 to 40 wt.-% of silicon dioxide.
6. The process of any one of the preceding embodiments, wherein the PGM collector alloy and the material capable of forming a slag-like composition when molten may be melted in a weight ratio of 1:0.2 to 1.
7. The process of any one of the preceding embodiments, wherein the temperature of the converter contents is raised to 1200 to 1800° C.
8. The process of any one of the preceding embodiments, wherein the contacting with the oxidizing gas takes 1 to 5 hours.
9. The process of any one of the preceding embodiments, wherein the immersion depth of the oxidizing gas exhaust into the lower high-density molten mass is in the range of from >0 to 10 cm.
10. The process of any one of the preceding embodiments, wherein the melting point is above 1800° C.
11. The process of any one of the preceding embodiments, wherein the gas lance takes a non-horizontal orientation during the oxidizing gas supply of step (4).
12. The process of any one of the preceding embodiments, wherein the ceramic material is selected from the group consisting of aluminum oxide, zirconium oxide, titanium dioxide, magnesium oxide, zinc oxide and aluminum titanate.
13. The process of any one of the preceding embodiments, wherein (i) the oxidizing gas is supplied (i) through all inner channels in downward direction or (ii) only through the central inner channel while at the same time cooling gas is supplied through the other inner channels or (iii) through two or more central inner channels while at the same time cooling gas is supplied in downward direction through the other inner channels.
14. The process of embodiment 13, wherein the cooling gas is air.
15. A gas lance which can be used in a process of any one of the preceding claims, said gas lance comprising or consisting of a rod having inner channels along its length axis, wherein the rod is made of a non-oxidizable ceramic material having a melting point above 1800° C.

### EXAMPLE

A premix of 500 kg of a PGM collector alloy comprising 47 wt.-% of iron, 14.1 wt.-% of nickel, 8.1 wt.-% of silicon, 4.6 wt.-% of palladium, 3.2 wt.-% of chromium, 2.5 wt.-% of titanium, 2.2 wt.-% of platinum, 1.8 wt.-% of manganese, 0.6 wt.-% of rhodium and 0.9 wt.-% of copper, 123 kg of calcium oxide, 75 kg of silicon dioxide, 15 kg of sodium carbonate and 15 kg of borax was portionwise introduced into an already 1500° C. hot cylindrical natural gas-heated furnace and further heated to 1700° C. After a melting time of 10 hours a two-phase system of a lower high-density molten mass comprising the PGM collector alloy and an upper low-density molten mass comprising a slag-like composition was formed. Oxygen was introduced into the lower high-density molten mass via the exhaust of an air-cooled alumina ceramic gas lance with an oxygen flow of 900 l/min.

The air-cooled gas lance was comprised of a 1.70 meters long circular rod of alumina ceramic, the rod having a diameter of 5 cm and having a central inner circular channel for the oxygen gas supply. The central inner channel was equidistantly surrounded by a first ring of 6 inner circular channels and a second ring of 12 inner circular channels, said 18 inner circular channels serving as cooling air supply. All 19 inner circular channels had a diameter of 3 mm. Air-cooling was performed with a total air flow of 2500 l of air of 20° C. per minute.

After 2.5 hours the oxygen introduction was stopped and the gas lance was removed. The upper low-density molten mass was poured into cast iron slag pots in order to cool down and solidify. The lower high-density molten mass was then poured into graphite molds in order to cool down and solidify. After solidification and cooling down to ambient temperature both materials were analyzed by XRF.

### Results:

1. The PGM enriched alloy comprised 16 wt.-% of iron, 53 wt.-% of nickel, 3 wt.-% of copper and 28 wt.-% of PGMs (platinum plus palladium plus rhodium).
2. The slag comprised 47 wt.-ppm of PGMs, 31 wt.-% of iron and 1 wt.-% of nickel.
3. The gas lance showed some damage but could be used for the same procedure a second time.

1. A process for the production of a PGM-enriched alloy comprising at least one PGM selected from the group consisting of platinum, palladium and rhodium, the process comprising the steps:
(1) providing a PGM collector alloy comprising collector metal and one or more PGMs selected from the group consisting of platinum, palladium and rhodium,
(2) providing a material capable of forming a slag-like composition when molten,
(3) melting the PGM collector alloy and the material capable of forming a slag-like composition when molten within a converter until a multi- or two-phase system of a lower high-density molten mass comprising the molten PGM collector alloy and one or more upper low-density molten masses comprising the molten slag-like composition has formed,
(4) contacting an oxidizing gas comprising 0 to 80 vol.-% of inert gas and 20 to 100 vol.-% of oxygen with the lower high-density molten mass obtained in step (3) until it has been converted into a lower high-density molten mass of the PGM-enriched alloy,
(5) separating an upper low-density molten slag formed in the course of step (4) from the lower high-density molten mass of the PGM-enriched alloy making use of the difference in density,
(6) letting the molten masses separated from one another cool down and solidify, and
(7) collecting the solidified PGM-enriched alloy,
wherein the contact between the oxidizing gas and the lower high-density molten mass is made by passing the oxidizing gas into the lower high-density molten mass by means of a gas lance the oxidizing gas exhaust of which being immersed into the lower high-density molten mass,
wherein the gas lance comprises or consists of a rod having inner channels along its length axis,
wherein the rod is made of a non-oxidizable ceramic material having a melting point higher than the temperatures prevailing during step (4), and
wherein the oxidizing gas is supplied through at least one of said inner channels.

2. The process of claim 1, wherein the PGM-enriched alloy comprises >0 to 60 wt.-% of iron and 20 to <100 wt.-% of the one or more PGMs.

3. The process of claim 1, wherein the PGM collector alloy provided in step (1) comprises 30 to 95 wt.-% of iron and 2 to 15 wt.-% of one or more PGMs selected from the group consisting of platinum, palladium and rhodium.

4. The process of claim 1, wherein the molten slag-like composition comprises or consists of 40 to 90 wt.-% of magnesium oxide and/or calcium oxide, 10 to 60 wt.-% of silicon dioxide, 0 to 20 wt.-% of iron oxide, 0 to 10 wt.-% of sodium oxide, 0 to 10 wt.-% of boron oxide, and 0 to 2 wt.-% of aluminum oxide.

5. The process of claim 4, wherein (i) the PGM collector alloy comprises 0 to 4 wt.-% of silicon and wherein the the molten slag-like composition comprises 40 to 60 wt.-% of magnesium oxide and/or calcium oxide and 40 to 60 wt.-% of silicon dioxide or (ii) wherein the PGM collector alloy comprises >4 to 15 wt.-% of silicon and wherein the the molten slag-like composition comprises 60 to 90 wt.-% of magnesium oxide and/or calcium oxide and 10 to 40 wt.-% of silicon dioxide.

6. The process of claim 1, wherein the PGM collector alloy and the material capable of forming a slag-like composition when molten may be melted in a weight ratio of 1:0.2 to 1.

7. The process of claim 1, wherein the temperature of the converter contents is raised to 1200 to 1800° C.

8. The process of claim 1, wherein the contacting with the oxidizing gas takes 1 to 5 hours.

9. The process of claim 1, wherein the immersion depth of the oxidizing gas exhaust into the lower high-density molten mass is in the range of from >0 to 10 cm.

10. The process of claim 1, wherein the melting point is above 1800° C.

11. The process of claim 1, wherein the gas lance takes a non-horizontal orientation during the oxidizing gas supply of step (4).

12. The process of claim 1, wherein the ceramic material is selected from the group consisting of aluminum oxide, zirconium oxide, titanium dioxide, magnesium oxide, zinc oxide and aluminum titanate.

13. The process of claim 1, wherein (i) the oxidizing gas is supplied (i) through all inner channels in downward direction or (ii) only through the central inner channel while at the same time cooling gas is supplied through the other inner channels or (iii) through two or more central inner channels while at the same time cooling gas is supplied in downward direction through the other inner channels.

14. The process of claim 13, wherein the cooling gas is air.

15. A gas lance which can be used in a process of any one of the preceding claims, said gas lance comprising or consisting of a rod having inner channels along its length axis, wherein the rod is made of a non-oxidizable ceramic material having a melting point above 1800° C.
